(19) United States
(12) Patent Application Publication
(10) Pub. No.: US 2001/0030201 A1
(43) Pub. Date: Oct. 18, 2001

(54) Water delivery 7 dispensing system

(76) Inventor: John Marvin Gerhardt, Las Vegas, NV (US)

Correspondence Address: JOHN MARVIN GERHARDT, 9457 LAS VEGAS BLVD. SO. #28, LAS VEGAS, NV, 89123, US

(21) Appl. No.: 09/750,384

(22) Filed: Dec. 27, 2000

Related U.S. Application Data
(60) Provisional application No. 60/173,125, filed on Dec. 27, 1999.

(51) Int. Cl. B67D 5/44

(52) U.S. Cl. 222/333; 222/385; 222/382; 222/464.1

(57) ABSTRACT

A two-part bottle water delivery system. A separate pump unit (84) snaps into a typical commercial water bottle (86). The bottom draw pump (18) is shaft driven (14). The separate placement of pump (18), feedline (32), drive shaft (14), and drawlines (22) into the bottle (86) allows all water contact items to be submitted to the commercial bottle cleaning and sterilization process. This assures maximum purity within the typical sealed plastic cap. The corresponding control/motor (82) automatically activates by switch (42) upon insertion into bottle (86). Water flow control is upon demand by pressure switch (34). Control/motor (82) and pump unit (86) are designed with exact one position alignment. Dispensing is accomplished by a reversible mounting (78) self-adhering (68) valve (80) incorporating a flat tube (54) capable of bypassing the typical magnet seal (56) on a conventional refrigerator. The seal is maintained and tube protected by a bridge (66).

### RELATED APPLICATIONS

This patent application is claiming the benefits of the U.S. Provisional Application having an application No. of 60/173/125 filed Dec. 27, 1999, in the name of John M. Gerhardt, and entitled “WATER DELIVERY AND DISPENSING SYSTEM”.

### BACKGROUND OF THE INVENTION

1. Field of the Invention

This invention relates to liquid delivery and, more specifically, to a water delivery and dispensing system from a containment device that is standard to the bottle water industry, said delivery maintained in a clean and simple system in all appropriate use areas.

2. Description of the Prior Art

Presently, there are many different types of water delivery and dispensing devices out in the market place. While these devices do work, there are several problems associated with them. First, most water delivery and dispensing devices are, by design, subject to contamination. These devices are difficult to clean and purge, and as such, rapidly become breeding grounds for bacteria and other unacceptable conditions such as dirt, hazardous materials, etc.

Another problem associated with present water delivery and dispensing systems, is that they are difficult to operate in reference to usability. Such difficulties are described as the cumbersome lifting and inverting of heavy water bottles. The present devices are bulky and take up considerable volume in areas more appropriate for other uses. The available systems are complicated to use when incorporated with existing devices such as refrigerators with or without ice makers and/or water dispensers, RV type vehicles, ice chests, typical drinking water fountains, etc.

Another problem with present water delivery and dispensing systems is they are not designed for use in the dental or medical professions, in reference to providing a controlled flow upon demand of liquid, such as water, that can be maintained in a pure or custom blend, as said profession requires.

Another problem with the present water delivery and dispensing systems is the lack of a simple, economical, dependable dispenser valve that can be used in conjunction with a common chiller unit, such as a refrigerator, ice chest, or simply wall or cabinet mounted to dispense liquid or water from an appropriate source.

Another problem with the present water delivery and dispensing systems is that they are limited to the storage capacity of the simple containment vessel, such as the five gallons available in the common water bottle industry's bottle. Multiple bottle systems are not available.

Another problem with the present water delivery and dispensing systems is that they are designed for short term temporary use, and operate by the simplest battery power or by a manual pump action.

Another problem is that all existing water delivery and dispensing systems that remove liquid from typical bottle water containers use methods that require inserting and transferring some type of apparatus in and out of the intended consumable liquid, thus maximizing the opportunity to contaminate the liquid.

Therefore, a need for a water delivery and dispensing system exists. This system must be simple to install, maintain, and operate. This system must eliminate the need to lift and invert heavy bottles of liquid, or the storage of bottles in close proximation of the dispensing location. The system must maximize cleanliness by avoiding the need to insert any items into the liquid. A need exists for a system that is so simple to operate that after removing the bottle seal, the control/motor unit is simply set in place in the throat of the bottle. The water begins to flow from the pump that is separately submersed in the bottle and the flow continues through the control/motor unit to its use destination.

### SUMMARY OF THE INVENTION

In accordance with one embodiment of the present invention, it is an objective of the present invention to provide an improved water delivery and dispensing system.

It is another objective of the present invention to provide a simple, efficient, reliable quiet method to pump, pressurize upon demand, flowable liquid or water to a use or consumption point.

It is another objective of the present invention to provide a method for use in the dental and medical professions, or any area that needs a device that removes a liquid or water from a containment vessel, and delivers a flow, on demand to a preferred use destination and/or a dispenser valve.

It is another objective of the present invention, to provide multiple use and safety, by the use of low voltage, electrical energy power.

It is another objective of the present invention to provide a method to deliver controllable, pressurized water or liquid from a typical bottle water industry bottle to a use location or dispenser without lifting or inverting said bottles.

It is another objective of the present invention to provide a simple water delivery device engineered so all possible delivery parts that contact the liquid or water are simply snapped securely into a typical commercial bottle water industry bottle and therefore exposed to the typical cleaning and sterilization process subjected to the bottle, whereupon after filling and sealing all possible delivery equipment is protected from contamination.

It is another objective of the present invention to provide a device that by incorporating prior art currently available in the marketplace can be joined into a multiple operation capable of transferring automatically from bottle to bottle.

### BRIEF DESCRIPTION OF THE PREFERRED EMBODIMENTS

In accordance with one embodiment of the present invention a water delivery and dispensing system is disclosed. The system is comprised of a snap in pump that is inserted and subjected to the bottle's cleaning and filling process. A control and motor unit is engineered to set on the bottle and upon activation, it rotates the pump and creates a liquid flow event that is then maintained by internal devices designed into the control motor unit. A dispensing valve is engineered to operate in appropriate use locations, such as a refrigerator, ice chest, or other described placements.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

FIG. 1 is a perspective view of the delivery portion of the invention which consists of two parts. One part is a motor and liquid control unit. The other is the separate pump unit as it sits in the typical bottle water industry's bottle.

FIG. 2 is a cross section view of the delivery portion of the invention as it is separated into its two parts.

FIG. 3 is a cross section view that details the upper and lower in-bottle pump, and its relationship to the bottle displayed in sections.

FIG. 3A is a view of the pump unit as it appears in the top of the bottle.

FIG. 3B is a view of the control and motor base as it is designed to relate to the pump unit as displayed in FIG. 3A.

FIG. 4 is a perspective view of the dispenser as it relates to an installation on a typical refrigerator door.

FIG. 4B is a cross section view that details the bridge as it is used to bypass the magnetic seal as it is found on a typical refrigerator door.

FIG. 4A is a perspective view of the dispenser valve as it appears in the open position.

FIG. 5 is a view of the dispensing valve part of the invention.

FIG. 5A is a cross section of the dispensing valve of the invention in its closed and open position.

FIG. 6 is a view of the dispensing valve in its open position.

FIG. 6A is a cross section view of the dispensing valve portion of the present invention with special detail to the valve seal.

FIG. 6B is a view of the tubing connectors that exist on the end of the feedline to the present invention's dispensing valve also used to feed water or liquid into the refrigerator.

### DETAILED DESCRIPTION OF THE PREFERRED EMBODIMENT

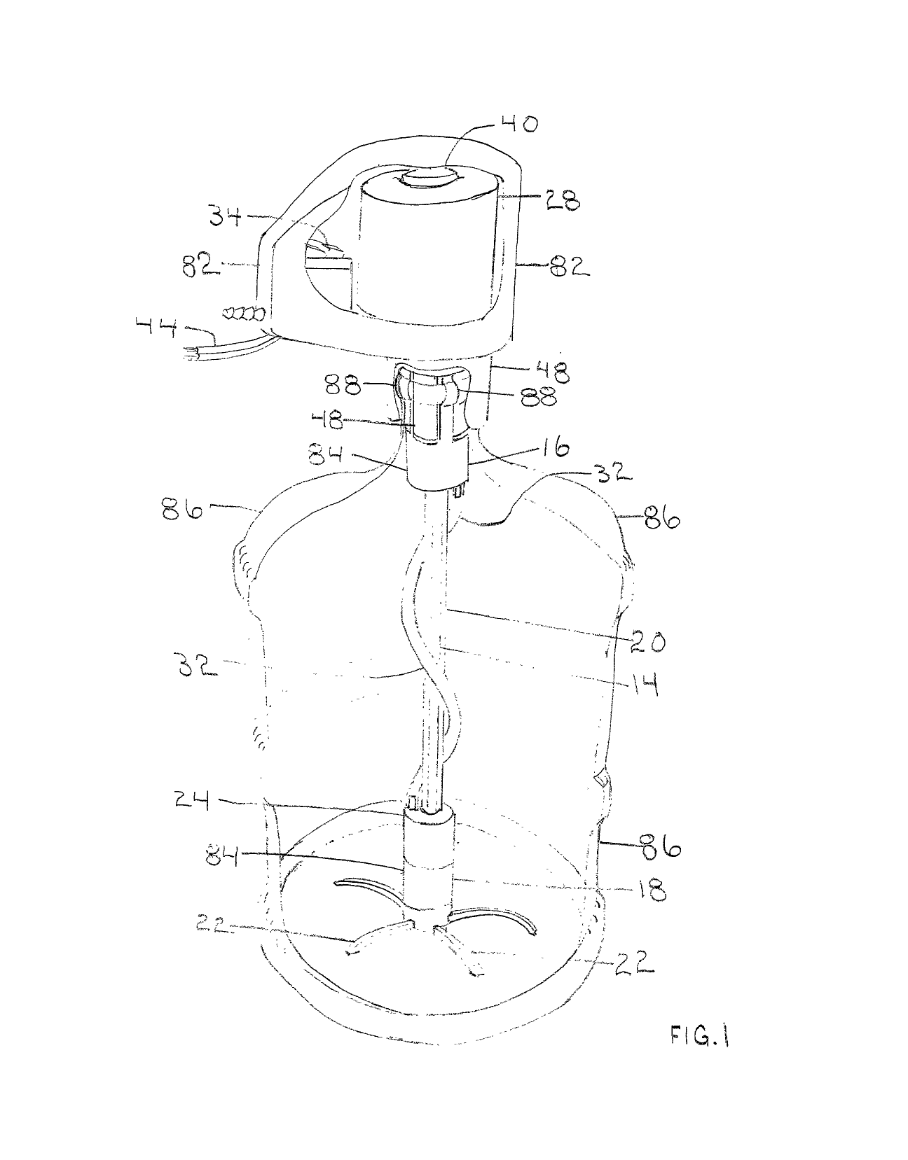

With reference to the drawings in greater detail, there is illustrated herein the bottled water delivery system FIGS. 1-3, and also the dispensing valve with access into and out of refrigerator water line.

This system is created to be used with a typical plastic water bottle 86 commonly used by the commercial bottled water industry.

With reference to the drawings FIGS. 1-3 shows the invention in different stages of detail. This invention is designed as a self-contained water delivery system, but it also can be used to deliver other liquids that are compatible with the materials used to manufacture this invention.

The delivery side of this invention consists of two parts. These parts are noted as control/motor 82 and pump unit 84 in FIGS. 1-3 and all the detail and function are identified by numbers. All numbers are the same in all drawings.

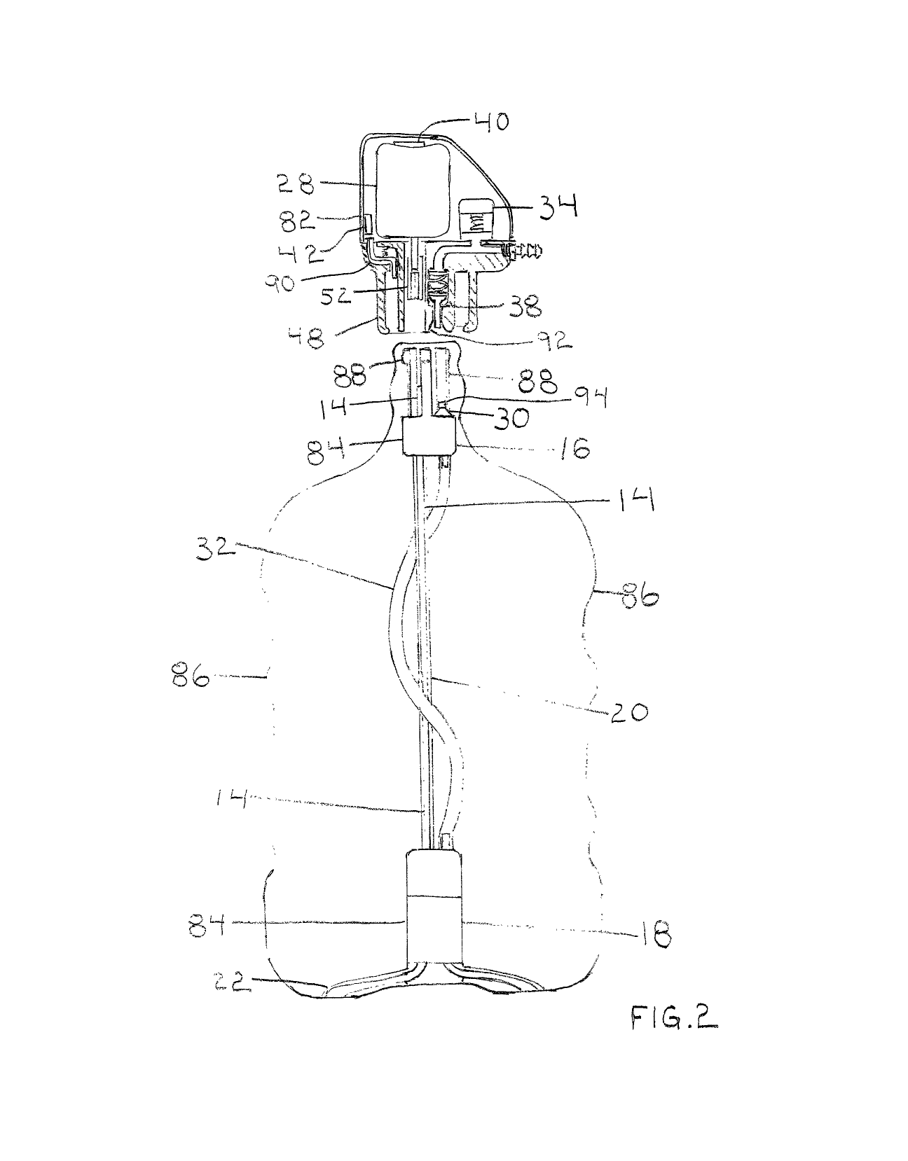

The delivery part of this invention as stated is two separate units. The motor/control 82 is detailed primarily on FIG. 2, and its function is covered further into this text.

The pump unit 84 is critical to the successful function of this invention, and as such is detailed first.

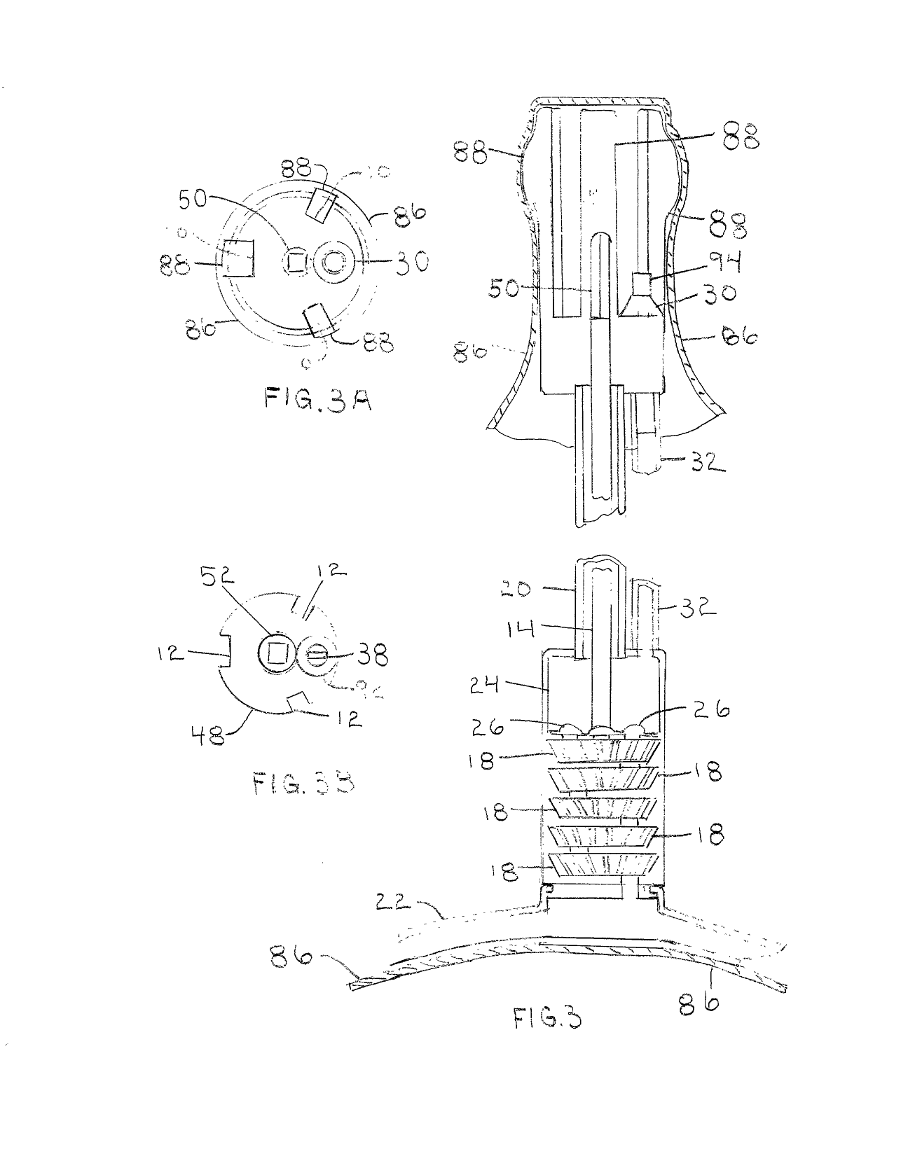

As noted in FIG. 2 the pump unit 84 is separate from the control/motor unit 82 for the purpose of being subjected to cleaning and sterilization along with the bottle 86. The pump unit 84 is designed to simply slide into the bottle 86 and snap in place in indentations on the pump unit's security snaps 88 located in bottle 86 throat. With pump unit 84 snapped and secured in place the pump unit 84 is in its proper place to accept the control/motor unit 82. This union is accomplished by the method detailed on FIG. 3. It should be observed that the control/motor guides on pump 10 on pump unit 84 that accept the control/motor's indentations on control/motor 82 into the saddle 16 on pump unit 84 is designed to match the corresponding grooves on control/motor unit 82. This configuration of control/motor guides on pump 10 and pump guides on control/motor 12 assures a simple and exact union of parts control motor unit 82 and pump unit 84. The pump unit 84 has a drive shaft 14 that extends from the saddle 16 to the multiple stage turbine pump 18. The drive shaft 14 is housed in an outer case 20 that holds saddle 16 to turbine pump 18. The invention has a flexible tubing 22 intake system attached to the base of the turbine pump 18 designed to draw all fluid completely from the plastic bottle 86. As fluid is drawn through the stages of the turbine pump 18 which is designed to be efficient and quiet due to its rotary action. Said fluid is designed to enter a pressure chamber 24. This pressure chamber 24 has in its base a plastic check valve gasket 26 designed to fit over four holes in the base of the pressure chamber 24. The plastic check valve gasket 26 will allow fluid to flow out but not allow for any back-flow (similar to gaskets found in reed carburetors), thus insuring operation of demand pressure switch 34 in control/motor unit 82. When operating, the turbine pump 18 forces fluid past the plastic check valve gasket 26 in pressure chamber 24 and through the outlet into an expandable tube 32. Upon exiting expandable tube 32 fluid enters control/motor unit 82 through flange with seal30 attached to protrusion 36.

Fluid now enters the control/motor unit 82. The external operation of control/motor unit 82 is designed with the following features: The out housing 48 is designed to snap securely to the exterior of the plastic bottle 86 neck. The motor shaft 14 has a square insert motor arbor 50 (female) designed to slide on to the pump shaft top 52 (male). Power is obtained upon seating control/motor unit 82 in place on the pump unit 84. This is accomplished by activation of linkage 90 leading to a micro-switch 42. This function insures operation is only possible upon proper alignment and seating of units. Power is from a 12V DC supply for safety and for crossover into various operations, power cord 48. With said power applied, function begins. Fluid passes through pump 84 into control/motor unit 82. At the point of the seal seat 92 located in base of control/motor unit 82 is a back-flow valve 38. This back-flow valve 38 is activated by a protrusion 36 which is located above the seal 30 on the saddle 16. As the control/motor unit 82 and pump unit 84 are joined, this protrusion 36 enters the water feed line 94 and defeats the back-flow valve 38. The purpose of this back-flow valve 38 is to prevent leakage at the point of transfer or removal of control/motor unit 82. It also maintains pressure and insures cleanliness. As fluid flows past the back-flow valve 38 and pressure switch 34, it now exits control/motor unit 82 to the desired point of use.

In the event the point of use is a desired venue for chilled drinking water, this system has an invention that allows for the use of a standard, typical refrigerator with minimal installation.

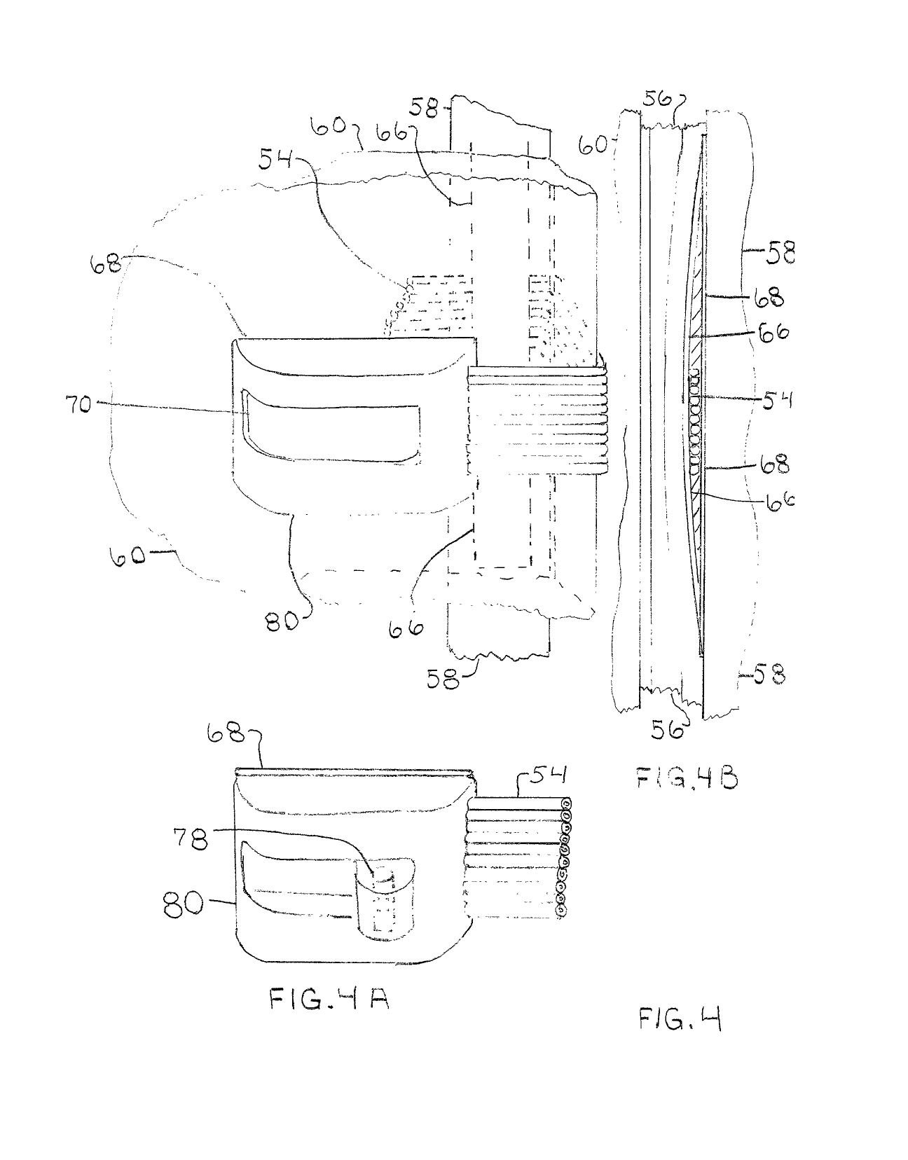

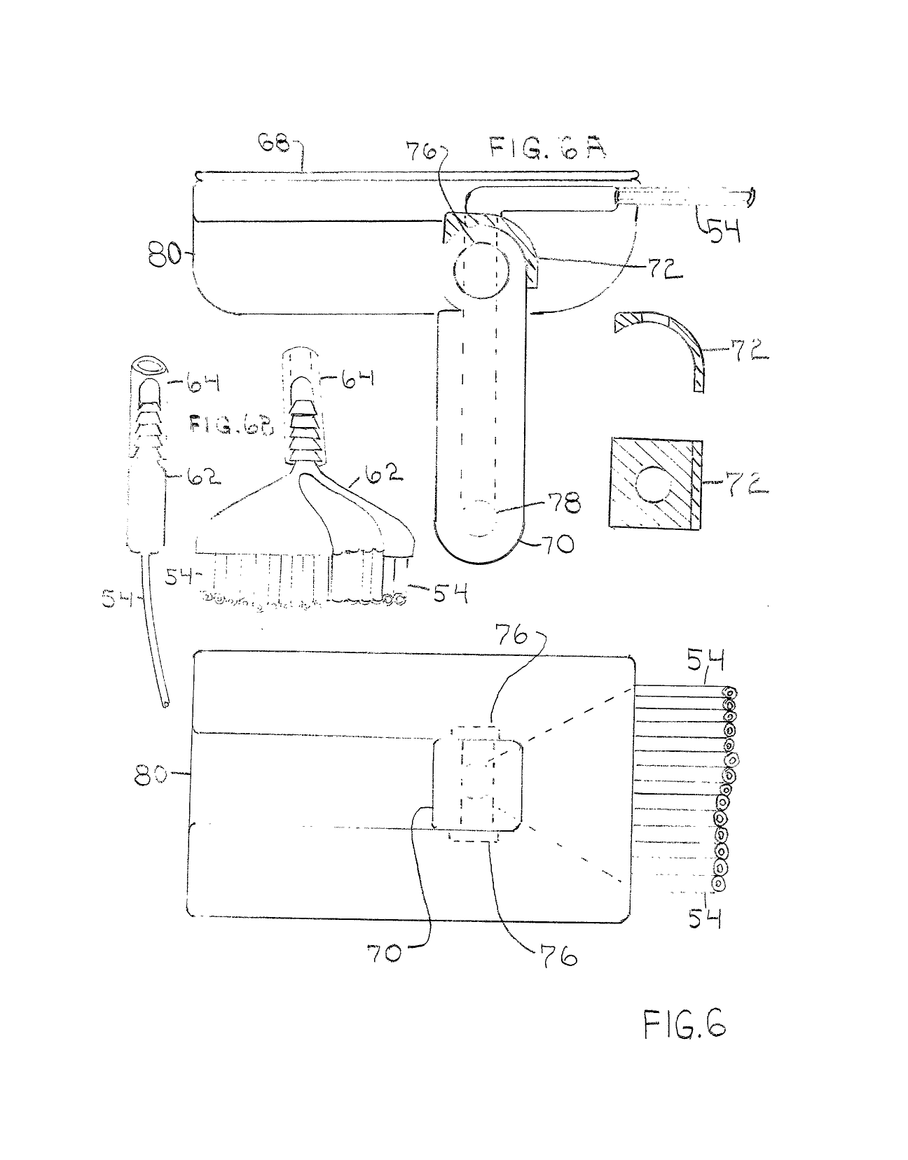

This function is accomplished by the use of the flat tubing 54 as shown on FIGS. 4-6. this flat tubing is designed to be located on the refrigerator wall 58 where the magnetic door seal 56 is located. The flat tubing 54 is constructed of an extremely flexible and durable material, and is used in two areas in this application. One area is to allow for the purpose of delivering liquid past the magnetic door seal 56 from the delivery system previously described (or other source if desired) to a chiller located in the refrigerator. This is accomplished by attaching the flat tubing 54 to the hose accepting ends 62 as detailed in FIG. 6. This part is designed to accommodate standard tubing 64. The other area is to deliver fluid from a chiller to the dispensing valve 80.

To prevent the door magnetic seal 56 from crushing the flat tubing 54, the use of a bridge 66 is necessary. This bridge 66 is designed to protect the tubing 54 and still allow for the magnetic seal 56 to function. The tubing bridge 66 is secured in place by the use of double-sided foam tape 68.

The use of flat tubing 54 allows for the function of the dispensing valve 80 is designed to be secured to a selected location such as, but not limited to, the front of the refrigerator door, by double-sided tape 68.

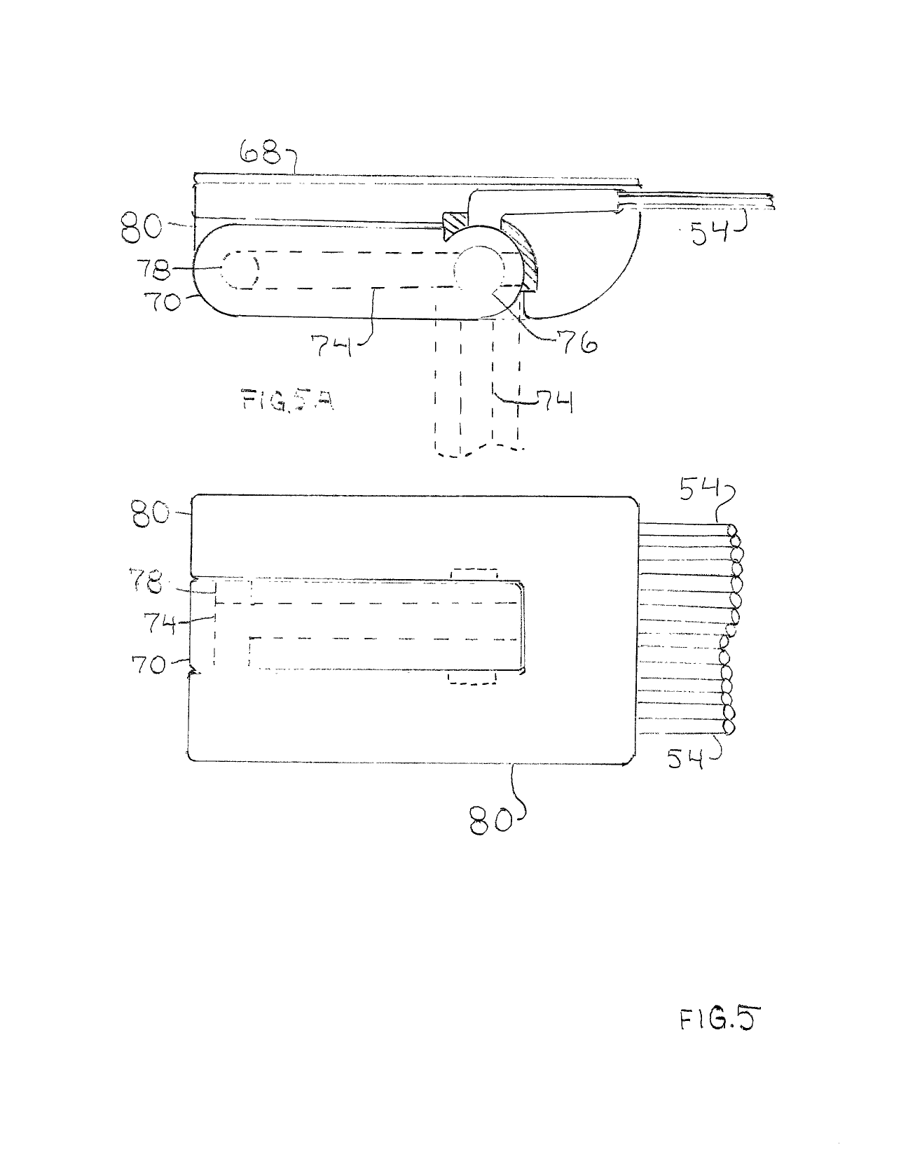

Operation of the dispensing valve 80 invention is accomplished as follows: The closed position is displayed on FIG. 5. When in the closed position the spout 70 is sealed against the rubber gasket 72 thus preventing any leakage. Upon positioning the spout 70 into its opened sealing position FIG. 6, the feed line 74 is positioned over the hole in the rubber gasket72 which allows for liquid to flow. Spout 70 is secured by pivots 76 as drawn in FIGS. 5 and 6. Spout 70 is designed with an outlet at the tip of feed line 74 which goes both ways. This design is to allow for reversal of direction of flow. The purpose of this option is so the dispensing valve 80 can face either way. Example: most refrigerator doors are reversible; this design accommodates this option. This selection is achieved by placing a plug 78 in top of spout 70 upon completion of installation.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A water delivery and dispensing system comprising, in combination with a pump unit that snaps into a containment vessel for the purpose of cleanliness and efficiency.
A water control and motor device that facilitates the operation of the pump unit.
A dispensing valve that controls the flow of water or liquid

2. A water delivery and dispensing system in accordance with claim 1 wherein the pump unit is a rotary turbine that is capable of cleaning and sterilization during the same filling and sealing process routinely associated with the bottle in a commercial operation.

3. A water delivery and dispensing system in accordance with claim 2 wherein the pump unit further comprises a snap-in feature that minimizes effort of installation and removal from commercially obtainable bottles while insuring the unit is held securely in its designated position in said bottle.

4. A water delivery and dispensing system in accordance with claim 2 wherein the pump unit is comprised of few moving parts to maintain an economical pump that is efficient and can run dry without causing harm.

5. A water delivery and dispensing system in accordance with claim 2 wherein a pump unit has a flexible feed line in its base to allow for maximum evacuation of liquid in accordance with the curvature of the existing bottle design.

6. A water delivery and dispensing system in accordance with claim 1 wherein the control and motor unit is comprised of a motor that is energized upon seating in the corresponding pump saddle.

7. A water delivery and dispensing system in accordance with claim 5 wherein the control motor unit, upon energizing of the motor unit, the activated pump unit initiates water flow that is controlled by achieving a maximum pressure causing motor operation to cease, and upon demand, causing a drop in water pressure, motor resumes and flow reinstated.

8. A water delivery and dispensing system in accordance with claim 5 wherein the motor unit's water flow is controlled by a check valve designed to prevent backflow at the occurrence of removal from the pump unit's saddle and bottle.

9. A water delivery and dispensing system in accordance with claim 2 wherein the control and motor unit comprises of a base drive design that upon proper seating in bottle on the pump saddle, the control motor unit is above the water line, thus insuring against contamination.

10. A water delivery and dispensing system in accordance with claim 1 where the dispenser valve is comprised of a design that is reversible and mountable by foam tape application.

11. A water delivery and dispensing system in accordance with claim 9 wherein the dispensing valve is designed with a seal that prevents water flow when in the closed position, and allows water flow when in the open position.

12. A water delivery and dispensing system in accordance with claim 9 wherein the dispensing valve is designed with a flat, multiple tube feedline that delivers an appropriate volume of water while maintaining a minimum profile to accommodate installation and usage desire.

13. A water delivery and dispensing system in accordance with claim 11 wherein a bridge unit is designed to secure the feedline with foam tape in the proper location to bypass the typical, magnetic seal found on most refrigerators for the purpose of introducing water into and out of the refrigerator.

14. A water delivery and dispensing system in accordance with claim 9 wherein the valve spout is compact in its closed position and at point of dispensing is extended to allow for all types of typical receptacles such as drinking glasses, coffee pots, etc.
